(19) United States
(12) Patent Application Publication
(10) Pub. No.: US 2015/0234746 A1
(43) Pub. Date: Aug. 20, 2015

(54) STORAGE DEVICE AND OPERATING METHOD

(71) Applicant: SAMSUNG ELECTRONICS CO., LTD., SUWON-SI (KR)

(72) Inventor: MYUNG HYUN JO, HWASEONG-SI (KR)

(21) Appl. No.: 14/488,156

(22) Filed: Sep. 16, 2014

(30) Foreign Application Priority Data
Feb. 14, 2014 (KR) 10-2014-0017388

(51) Int. Cl. G06F 12/08

(52) U.S. Cl. CPC G06F 12/0862; G06F 2212/2022

(57) ABSTRACT

An operating method for a storage device includes; in response to a first read command a memory controller reads first data from a nonvolatile memory and provides it to a host. The memory controller also anticipates a first prefetch address, reads first prefetch data from the nonvolatile memory in response to the first prefetch address and stores the first prefetch data in a memory. Upon receiving a second read command from the host, the memory controller determines whether the first prefetch data corresponds with second data stored in the nonvolatile memory as identified by the second address, and provides the first prefetched data from the memory to the host if it does. Thereafter, the first prefetch data stored in the memory is marked as trash data.

### CROSS-REFERENCE TO RELATED APPLICATIONS

This U.S. non-provisional patent application claims priority under 35 U.S.C. §119 to Korean Patent Application No. 10-2014-0017388 filed on Feb. 14, 2014, the subject matter of which is hereby incorporated by reference.

### BACKGROUND

The present inventive concept relates to semiconductor data storage device, computing systems including same, and operating methods for such storage devices.

As a semiconductor manufacturing technology develops, the operating speeds of many hosts such as general-purpose computers, mobile devices, etc. increase. This is necessary since the volume of data corresponding to contemporary media content is sharply increasing. Accordingly, semiconductor data storage device must operate with ever increasing speed.

### SUMMARY

Embodiments of the inventive concept provide an operating method for a storage device including a nonvolatile memory, a memory and a memory controller that controls the nonvolatile memory and memory. The method comprises; receiving in the memory controller a first read command and a corresponding first address from a host, in response to the first read command and by operation of the memory controller, reading first data from the nonvolatile memory in response to the first address, providing the first data to the host, anticipating a first prefetch address in response to the first address, reading first prefetch data from the nonvolatile memory in response to the first prefetch address, and storing the first prefetch data in the memory, receiving in the memory controller a second read command and a corresponding second address from the host following receipt of the first read command and the first address, determining on the basis of the first prefetch address and the second address whether the first prefetch data corresponds with second data stored in the nonvolatile memory as identified by the second address, and upon determining that the first prefetch data completely corresponds with the second data, providing the first prefetched data from the memory to the host, upon determining that the first prefetch data does not correspond with the second data, reading the second data from the nonvolatile memory, temporarily storing the second data in the memory and then providing the second data to the host, and marking the first prefetch data stored in the memory as trash data.

Embodiments of the inventive concept provide an operating method for storage device including a nonvolatile memory, a memory and a memory controller that controls the nonvolatile memory and memory. The method comprises; receiving in the memory controller a first read command and a corresponding first address from a host, in response to the first read command and by operation of the memory controller, reading first data from the nonvolatile memory in response to the first address, providing the first data to the host, anticipating a first prefetch address in response to the first address, reading first prefetch data from the nonvolatile memory in response to the first prefetch address, and storing the first prefetch data in the memory, receiving in the memory controller a second read command and a corresponding second address from the host following receipt of the first read command and the first address, determining on the basis of the first prefetch address and the second address whether a hit condition or a miss condition exists with respect to the first prefetch data and second data stored in the nonvolatile memory as identified by the second address, and upon determining that the hit condition exists, providing the first prefetched data from the memory to the host, upon determining that the miss condition exists, reading the second data from the nonvolatile memory in response to the second address, temporarily storing the second data in the memory and then providing the second data to the host, and marking the first prefetch data stored in the memory as trash data.

Embodiments of the inventive concept provide a storage device comprising: a nonvolatile memory, a memory; and a memory controller that receives a first read command and a corresponding first address from a host. In response to the first read command the memory controller is configured to read first data from the nonvolatile memory in response to the first address, provides the first data to the host, anticipates a first prefetch address in response to the first address, reads first prefetch data from the nonvolatile memory in response to the first prefetch address, and stores the first prefetch data in the memory. The memory controller also receives after the first read command a second read command and a corresponding second address from the host. In response to the second read command the memory controller is configured to determine on the basis of the first prefetch address and the second address whether the first prefetch data corresponds with second data stored in the nonvolatile memory as identified by the second address, and upon determining that the first prefetch data completely corresponds with the second data, the memory controller provides the first prefetched data from the memory to the host, upon determining that the first prefetch data does not corresponds with the second data, the memory controller marks the first prefetch data as trash data.

### BRIEF DESCRIPTION OF THE DRAWINGS

Embodiments of the inventive concept are described hereafter with reference to the accompanying drawings.

FIG. 1 is a general block diagram illustrating a computing device in accordance with embodiments of the inventive concept.

FIG. 2 is a block diagram further illustrating in one example the storage device 200 of FIG. 1.

FIG. 3 is a flow chart illustrating operation of the storage device 200 of FIGS. 1 and 2 in accordance with certain embodiments of the inventive concept.

FIG. 4 is a flow chart illustrating in one example the operation of the detector unit of FIG. 2.

FIG. 5 is a flow chart illustrating in one example the operation of the input/output unit of FIG. 2.

FIGS. 6 and 7 are flow charts respectively illustrating in different examples the operation of the prefetch unit of FIG. 2.

FIGS. 8, 9, 10, 11 and 12 are respective block diagrams illustrating various operations that may be performed by the storage device of FIG. 2.

FIGS. 13 and 14 are flow charts respectively illustrating in other examples the operation of the detector unit in FIG. 2.

FIG. 15 is a block diagram illustrating a nonvolatile memory in accordance with embodiments of the inventive concept.

FIGS. 16 and 17 are respective circuit diagrams variously illustrating certain examples of the memory block shown in FIG. 15.

FIG. 18 is a block diagram further illustrating in one example the memory controller 220 of FIG. 2.

FIG. 19 is a block diagram illustrating a computing device in accordance with certain embodiments of the inventive concept.

### DETAILED DESCRIPTION

Certain embodiments of inventive concept will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings like reference numbers and labels are used to denote like or similar elements.

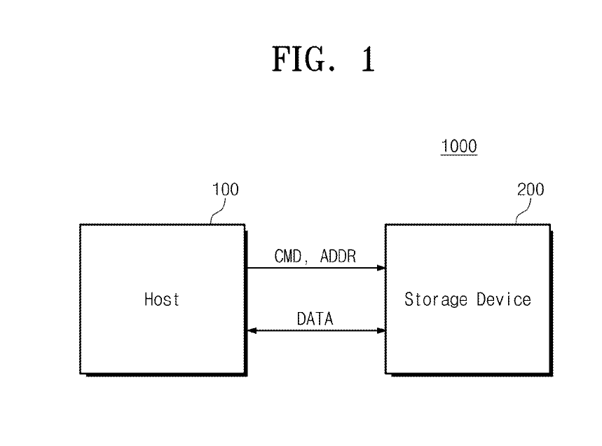

FIG. 1 is a block diagram illustrating a computing device 1000 in accordance with embodiments of the inventive concept. Referring to FIG. 1, the computing device 1000 generally comprises a host 100 and storage device 200.

During a read operation, the host 100 communicates a read command CMD and a corresponding address ADDR to the storage device 200, and receives “read data” DATA from the storage device 200. During a write (or program) operation, the host 100 communicates a write command, “write data” DATA, and a corresponding address to the storage device 200, and the write data is stored in the storage device 200. During an erase operation, the host 100 communicates an erase command and a corresponding address ADDR to the storage device 200, and data designated by the address is erased from (i.e., overwritten with an erase state value) the storage device 200.

The host 100 may be variously configured as a general-purpose computer, a special-purpose computer, a smart phone, a smart pad, a smart television, etc.

The storage device 200 may include a nonvolatile memory such as a flash memory, Phase-change Random Access Memory (RAM) (PRAM), a magnetic (MRAM), a resistance RAM (RRAM), etc. The storage device 200 may be configured as a solid state drive SSD, a detachable memory card, or an embedded device mounted within the host 100.

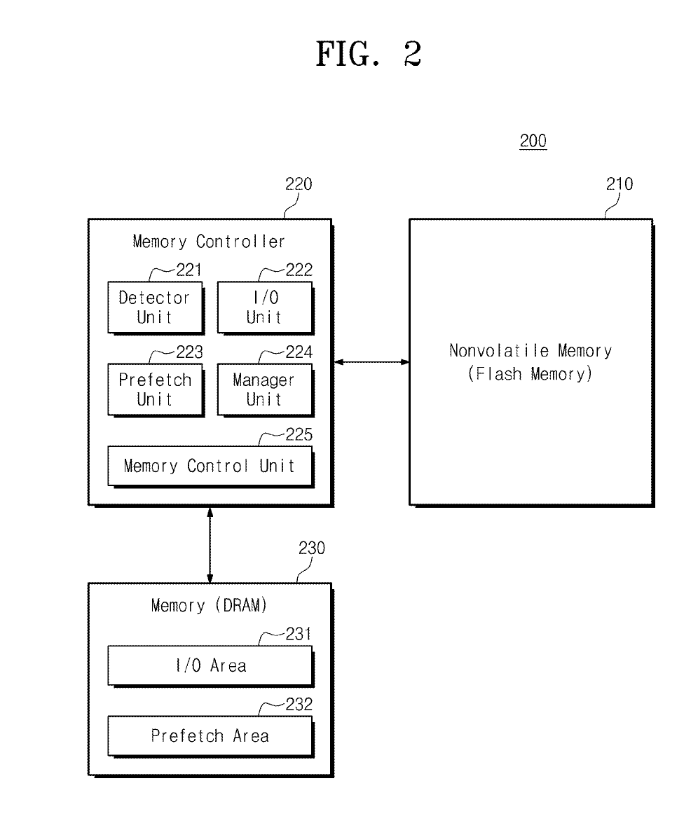

FIG. 2 is a block diagram further illustrating in one example the storage device 200 of FIG. 1. Referring to FIGS. 1 and 2, the storage device 200 comprises a nonvolatile memory 210, a memory controller 220 and a memory 230.

The nonvolatile memory 210 may be used to perform write, read and erase operations under the control of the memory controller 220. The nonvolatile memory 210 may include flash memory. However, the implementation of the nonvolatile memory 210 is not limited thereto.

The memory controller 220 is configured to control the overall operation of the nonvolatile memory 210 according to a predetermined schedule dictated by one or more “requests” of the host 100. In this context, each request may consist of one or more command(s), address(es) and/or corresponding data.

After performing a read operation in response to a read-request made by the host 100, the memory controller 220 may, under certain circumstances, perform a so-called “prefetch operation”. Prefetch operations may be variously defined and executed, but each essentially identifies “expecting data” (DATA_E or “prefetched data”) based on a previous read-request, and then executes a read operation directed to the expected data. Note the prefetching of the expected data is performed in advance of receiving a read-request from the host 100 identifying the expected data as part of a normal read operation.

Then, if read data identified by a subsequent read-request received from the host 100 is the same as the prefetched data (this computational outcome is referred to as a “hit”), then the prefetched data may be more rapidly provided to the host 100 by the memory controller 220 as compared with the provision of read data as the result of a normal read operation. This is particularly true since the prefetched data may be temporarily stored in a volatile memory, such as a Dynamic Random Access Memory (DRAM), that may be much more quickly accessed as compared with the nonvolatile memory 210.

However, if read data being requested by the host 100 is not the same as the prefetched data (this computational outcome is referred to as a “miss”) the memory controller 220 may mark the prefetched data (DATA_E) temporarily stored in the memory 230 as “trash data”. Thereafter, the memory controller 220 may periodically purge all data marked as trash data.

In the illustrated example of FIG. 2, the memory controller 220 comprises a detector unit 221, an input/output (I/O) unit 222, a prefetch unit 223, a manager unit 224 and a memory control unit 225.

The detector unit 221 may be used to determine whether or not read data currently being requested by the host 100 corresponds to stored prefetched data, and correspondingly provide a hit/miss signal indicating same.

The I/O unit 222 may be used to control the input (i.e., receipt) and the output (i.e., provision) of data by the memory controller 220. Thus, the I/O unit 222 may be used to communicate write data to the nonvolatile memory 210 as received from the host 100 during a write operation defined by a host generated write-request. In this regard, the write data may (or may not) pass through the memory 230 on the way to being stored in the nonvolatile memory 210.

The I/O unit 222 may also be used retrieve read data from the nonvolatile memory 210 and output same to the host 100 during a read operation as defined by a read-request generated by the host 100. For example, the I/O unit 222 can read data from the nonvolatile memory 210 and write the read data in the memory 230. Additionally, the I/O unit 222 may be used to retrieve data (e.g., prefetched data) stored in the memory 230 and communicate same to the host 100. In this manner, the I/O unit 222 may return prefetched data stored in the memory 230 in response to a read-request made by the host 100.

Further, the I/O unit 222 may be used to detect trash data stored in the memory 230 and purge (or release) the trash data. The detection and release of trash data may be performed periodically or in response to a specific command made by the memory controller 220.

The prefetch unit 223 may be used to perform a prefetch operation in response to a read-request (or possibly a write-request) made by the host 100. That is, the prefetch unit 223 may be used to anticipate an “expected address” (ADDR_E or “prefetch address”) on the basis of a read address associated with a previous read-request. The prefetch address is essentially a read address expected or anticipated by the memory controller 220 in relation to a next expected read-request made by the host 100. On the basis of the prefetch address, the prefetch unit 223 may be used to read prefetch data stored in the nonvolatile memory 210 and/or the memory 230. In this regard, the prefetch unit 223 may be used to manage prefetch data in accordance with requests received from the host 100. So, when prefetch data is missed by an incoming read-request, the prefetch unit 223 may be used to mark the prefetched data as trash data.

The manager unit 224 may be used to control the allocation and de-allocation of memory space provided by the nonvolatile memory 210. Thus, the manager unit 224 may control the use of nonvolatile memory 210 in response to access operations defined by the I/O unit 222 and/or prefetch unit 223. For example, should the I/O unit 222 and prefetch unit 223 simultaneously require certain read data stored in the nonvolatile memory 210, the manager unit 224 may be used to arbitrate these competing demands. Hence, the manager unit 224 may be used to retrieve data stored in the nonvolatile memory 210 in a defined order as determined by the manager unit 224 in response to access operations indicated by the I/O unit 222 and prefetch unit 223.

In this manner, the manager unit 224 controls access to the nonvolatile memory 210 in relation to read/write operations made by the I/O unit 222 as well as read operations made by the prefetch unit 223 by managing a command queue of “internal” read/write operations, as distinguished from “external read/write operations” requested by the host 100, for example. (Internal and external commands, as well as internal and external addresses, may be similarly distinguished).

The memory control unit 225 may be used to control access to the memory 230. Hence, the memory control unit 225 may be used to generate and communicate certain internal commands and corresponding addresses associated with the memory 230 using a data communication protocol compatible with the memory 230.

As may be understood from the foregoing, the memory 230 may be used, at least in part, as execution, buffer or cache memory by the memory controller 220. Additionally, the memory 230 may be used to store certain programming code capable of driving the operation of the memory controller 220, and/or to temporarily store write data during execution of a write operation or read data during execution of a read operation directed to the nonvolatile memory 210. And as previously noted, the memory 230 may be used to store prefetch data.

In the illustrated example of FIG. 1, the memory space provided by the memory 230 may be arbitrarily designated as including an input/output (I/O) area 231 and a prefetch area 232. The I/O area 231 may be used to temporarily store write data being written to the nonvolatile memory 210 or read data being retrieved from the nonvolatile memory 210 in response to a request by the host 100. In contrast, the prefetch area 232 may be specifically used to store prefetch data designated by the prefetch unit 224 and anticipatorily retrieved from the nonvolatile memory 210 even in the absence of a corresponding request made by the host 100.

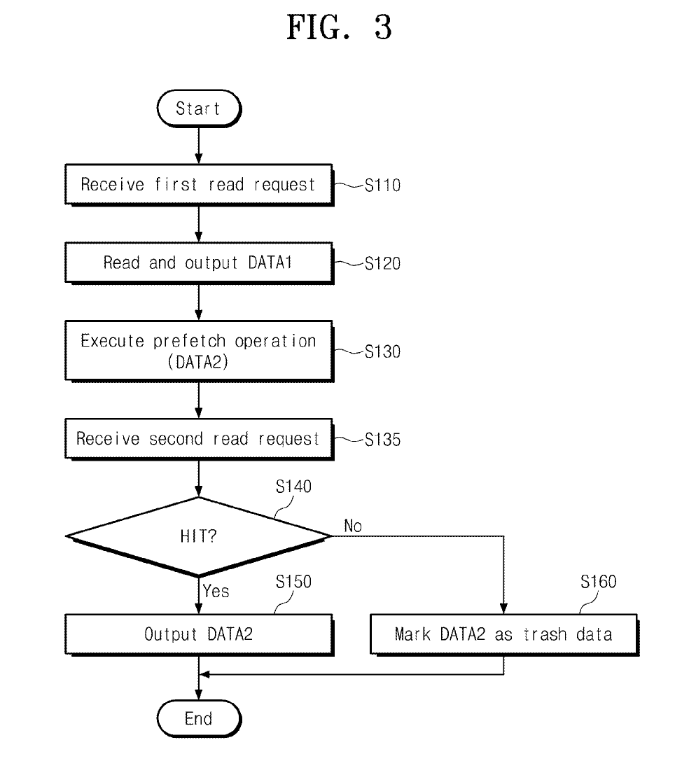

FIG. 3 is a flow chart illustrating operating method for a storage device in accordance with embodiments of the inventive concept. Referring to FIGS. 1, 2 and 3, a first read request is received from the host 100 in the memory controller 220 (S110).

Then, first read data (DATA1) associated with the first read request is read from the nonvolatile memory 210 and output to the host 100 (S120). The first read data (DATA1) may be temporarily stored in the I/O area of the memory 230 during execution of a first read operation defined by the first read request.

Also in response to the first read request, the memory controller 220 will cause the execution of a prefetch operation directed to prefetch (or second) data (DATA2) that is anticipated as the result of the first read request (S130). As the result of the prefetch operation, the prefetch data (DATA2) will be is read from the nonvolatile memory 210 and stored in the prefetch area 232 of the memory 230.

Upon receiving a second read request following the first read request (S135), the memory controller will determine whether or not a prefetch cache “HIT” has occurred (S140).

If a hit condition is determined (S140=Yes), the prefetch data (DATA2) is output from the memory 230 (S150). If not (S140=No), the prefetched data (DATA2) is marked as trash data (S160). In this manner, the prefetched data may be quickly returned from the memory 230 to the host 100 in response to the second read request.

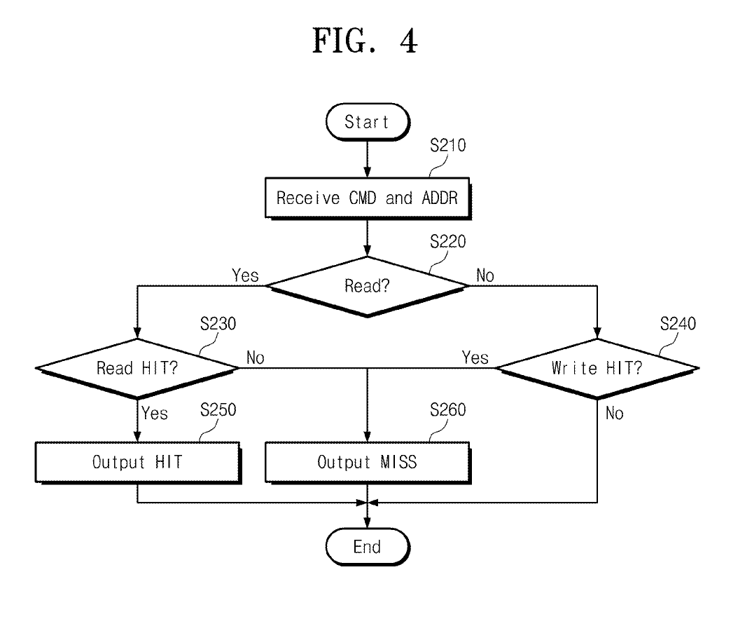

FIG. 4 is a flow chart illustrating in one example operation of the detector unit 221 in a method according to embodiments of the inventive concept. Referring to FIGS. 1, 2 and 4, the detector unit 221 may receive a command CMD and a corresponding address ADDR from the host 100 as part of a current request (S210).

If the received command CMD is determined to be a read command (S220=Yes), then a following determination is made as to whether or not the received command and address create a read hit condition (S230). For example, if the prefetch unit 223 determines that the received read address corresponds with a stored prefetch address associated with stored prefetch data (S230=Yes), then the prefetch data may be output in response to the read command, and a read HIT condition may be indicated (S250).

For example, the detector unit 221 may be used to receive information (e.g., the prefetch address) related to a prefetch operation from the prefetch unit 223 and compare the received information to stored “hit condition information” (e.g., a prefetch address). And upon determining that a read hit condition exists (S230=Yes), the detector unit 221 may be used to output a defined HIT signal (S250). However, if it is determined by a comparison of the received information and stored hot condition information that a hit condition is not indicated (S230=No), then the detector unit 221 may be used to output a defined MISS signal (S260).

If the received command CMD is not a read command but is instead a write command (S220=No), a following determination is made as to whether the write address received with the write command corresponds with a stored prefetched address (S240). If the write address is the same as a prefetch address, for example, a write hit condition may be determined (S240=Yes). That is, the detector unit 221 may be used to receive and store hit condition information (e.g., a prefetch address) from the prefetch unit 223 and compare the received information with stored hit condition information.

If it is determined that the received information and the stored hit condition information indicate a write hit condition (S240=Yes), the detector unit 221 may be used to output a MISS signal (S260).

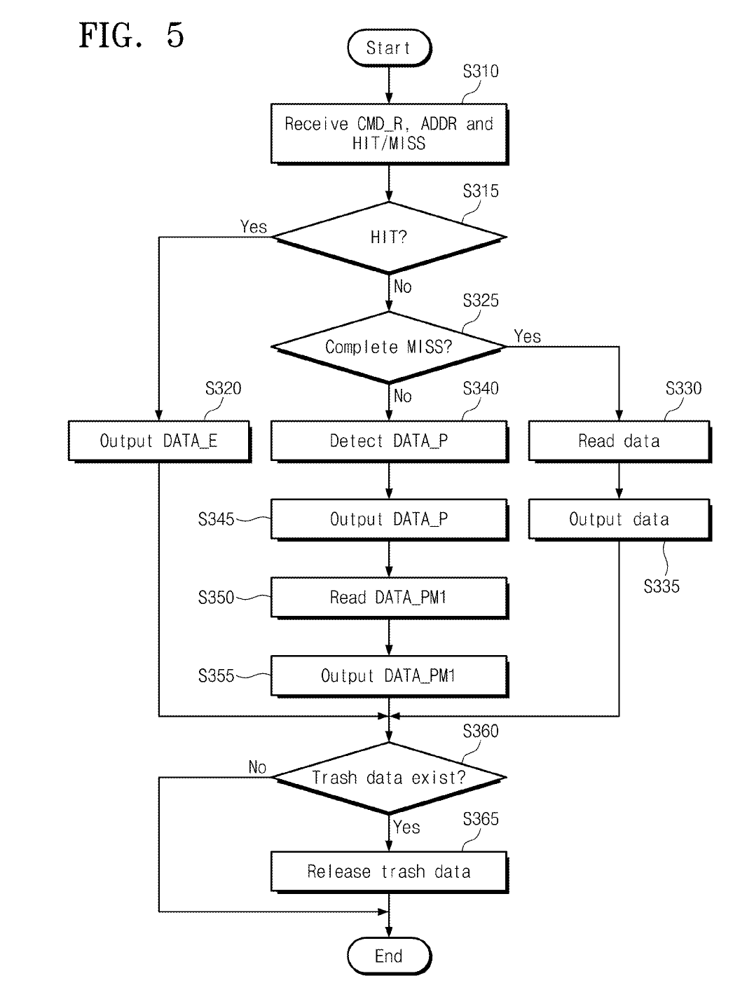

FIG. 5 is a flow chart illustrating in one example operation of the I/O unit 222 of FIG. 2 in a method according to embodiments of the inventive concept. Referring to FIGS. 1, 2 and 5, the I/O unit 222 receives a read command together with a corresponding address and a HIT/MISS control signal (CMD_R, ADDR and HIT/MISS) (S310).

Then, the I/O unit 222 determines whether or not the HIT/MISS signal received from the detector unit 221 indicates a hit condition (S315=Yes). Read hit conditions determination may be performed as described above. If a read hit condition is determined, the I/O unit 222 causes the prefetched data (DATA_E) to be output to the host 100 in response to the received read command (S320). For example, in a case where all of the prefetched data has previously been stored in the prefetch area 232 of the memory 230 by the prefetch unit 223, the I/O unit 222 may simply (and immediately) output the perfected data. However, in cases where some or all of the prefetched data (DATA_E) is still being fetched from the nonvolatile memory 210 to the prefetch area 232 of the memory 230 by the prefetch unit 223, the I/O unit 222 will wait until all of the prefetched data is stored in the memory 230 before outputting the prefetched data to the host 100.

Where the HIT/MISS signal indicates a read miss condition (S315=No), a following determination is made as to whether or not the “miss” was a “complete miss” (S325). For example, the I/O unit 222 may determine that read data requested by the read command CMD is completely different from stored prefetch data (DATA_E), again based on a comparison of respective addresses. When part of a received address (ADDR) coincides with part of a prefetch address, the I/O unit 222 can determine that received MISS signal indicates “a partial miss” and also “a partial hit” (S325-=No).

When a complete miss is determined (S325=Yes), the data indicated by the received address (ADDR) is read from the nonvolatile memory 210 using the I/O unit 222 and manager unit 224 (S330) and output to the host 100 (S335). The read data retrieved from the nonvolatile memory 210 may be temporarily stored in the I/O area 231 of the memory 230.

However, when a partial hit is determined (S325=No), the I/O unit 222 may be used to determine partial hit data (DATA_P) among the stored prefetch data (DATA_E) (S340). For example, the I/O unit 222 may detect the partial hit data on the basis of compared addresses between the received address and stored prefetch address.

The I/O unit 222 may then be used to output the partial hit data to the host 100 (S345). As before in a case where all of the prefetch data has been stored in the memory 230, the I/O unit 222 may immediately output the partial hit data from among the prefetched data to the host 100. In cases where some or all of the prefetch data is not yet stored in the memory 230, the I/O unit 222 will wait until it is before outputting the partial hit data.

The I/O unit 222 may then be used to read partial miss data (DATA_PM1) that unlike the partial hit data (DATA_P) does not coincide with the stored prefetched data (DATA_E) as indicated by the received read command (S350). The partial miss data DATA_PM1 may instead be read from the nonvolatile memory 230 and stored in the I/O area 231 of the memory 230. Once reading and temporary storing of the partial miss data is complete, it may be output to the host 100 (S355) using the I/O unit 222.

In this foregoing context, either one of the partial hit data or the partial miss data may first be provided to the host 100. And these two data sets may be independently provided or may first be collected using (e.g.) the memory 230 before being provided to the host 100.

The method illustrated in FIG. 5 also includes a step of determining whether or not trash data exist in the memory 230 following provision of the requested read data to the host 100 (S360). That is, the I/O unit 222 may be used to determine whether or not trash data exists in the prefetch area 232 of the memory 230. The trash data among data stored in the prefetch area 232 may have a separate identification mark. For example, data being stored in the prefetch area 232 can be stored together with a state bit indicating state information. Data that the state bit is set to a first value can be judged not to be the trash data. Data that the state bit is set to a second value can be judged to be the trash data.

If trash data exists, the I/O unit 222 may be used to release the trash data from the memory 230 (S365).

As described with reference to FIG. 5, the I/O unit 222 may be used to determine the existence of trash data, and to release the trash data whenever read data is communicated to the host 100. However, this need not always be the case. For example, the I/O unit 222 might release trash data after a certain number of read operations have been executed, or periodically as a function of operating time, etc.

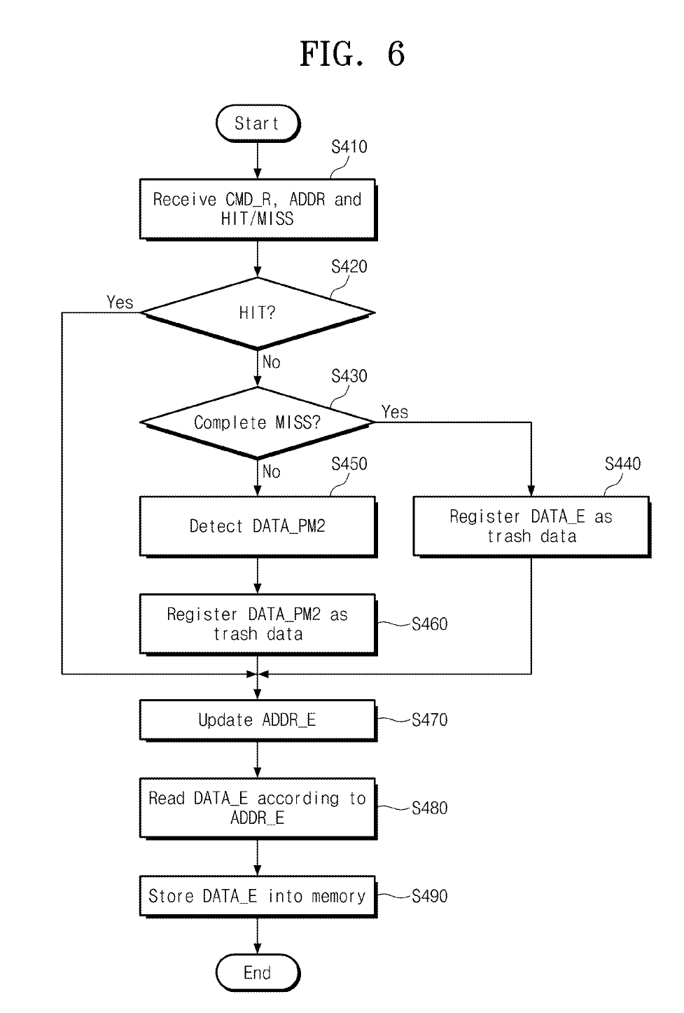

FIG. 6 is a flow chart illustrating in one example operation of the prefetch unit 223 in a method according to embodiments of the inventive concept. Referring to FIGS. 1, 2 and 6, the prefetch unit 223 receives the read command, address and HIT/MISS signal previously described (CMD_R, ADDR and HIT/MISS) (S410).

In response, the prefetch unit 223 determines whether a HIT/MISS signal received from the detector unit 221 indicates a hit (S420). If a hit is not indicated and a miss condition therefore indicated (S420=No), a following determination is made as to whether or not the corresponding miss is a complete miss (S430). For example, the prefetch unit 223 may be used to determine whether the data requested by the read command is completely different from stored prefetched data (DATA_E). In this regard, the prefetch unit 223 may be used to compare the received address (ADDR) with a prefetch address corresponding to stored (or currently being stored) prefetched data. When part of the received address corresponds to at least part of the prefetch address, the prefetch unit 223 will determine that the miss is a partial miss. However, when no part of the received address corresponds with the prefetch address, the prefetch unit 223 will determine that the miss is a complete miss.

If it is determined that the miss is a complete miss (S430=Yes), the prefetch unit 223 will mark (or register) the whole of the prefetched data (DATA_E) stored in the prefetch area 232 of the memory 223 as a trash data (S440). For example, the prefetch unit 223 may update an identification mark associated with the prefetched data to indicate trash data.

In contrast, if the miss is determined to be a partial miss (S430=No), the prefetch unit 223 may be used can identify (i.e., detect) partial miss data (i.e., data not requested by the received read command, or DATA_PM2) in relation to the prefetched data (S450). For example, the prefetch unit 223 may be used to detect partial miss data on the basis of a comparison between the received address and a prefetch address.

Then, the prefetch unit 223 may be used to register the partial miss data (DATA_PM2) as the trash data (S460).

After registering trash data (either step S460 or step S440) or upon determining that a hit condition is indicted (S420=Yes), the prefetch unit 223 may be used to update the prefetch address (ADDR_E) (S470). Here, the prefetch address may be updated on the basis of the received address (ADDR), a next address consecutive to the received address ADDR, or a predetermined address pattern, for example.

The prefetch unit 223 may then be used in conjunction with the manager unit 224 to perform a read operation directed to the prefetch data (DATA_E) using the updated prefetch address (S480). The prefetched data read in relation to the updated prefetch address may be stored in the prefetch area 232 of the memory 230 (S490).

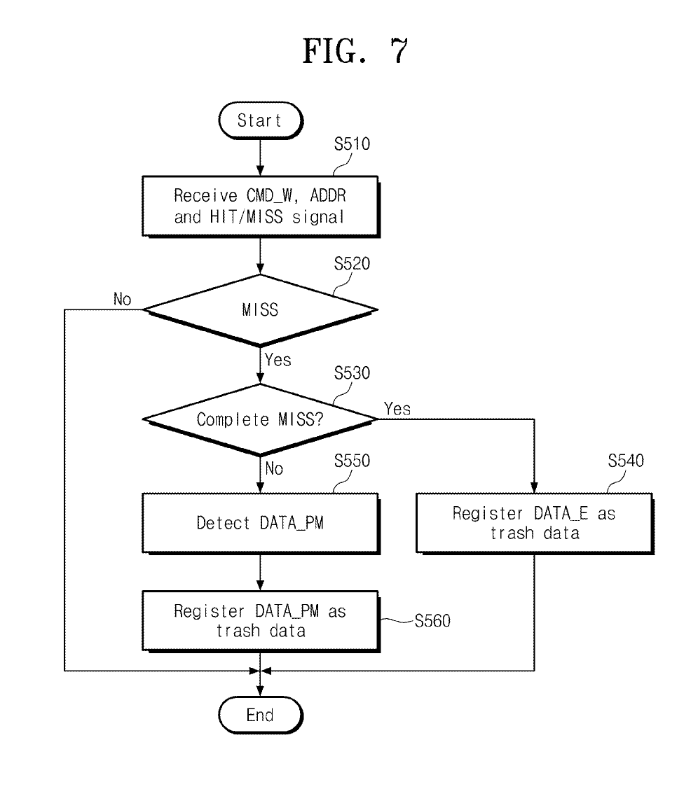

FIG. 7 is a flow chart illustrating in one example operation of the prefetch unit 223 of FIG. 2 in relation to a method according to embodiments of the inventive concept. Referring to FIGS. 1, 2 and 7, the prefetch unit 223 again receives a write command (CMD_W), an address (ADDR) and/or the HIT/MISS signal (S510).

The prefetch unit 223 may then be used to determine whether or not the HIT/MISS signal received from the detector unit 221 indicates a miss condition (S520). Upon receiving an indication of a miss condition (S520=Yes), a following determination is made as to whether or not the miss was a complete miss (S530), as has been previously described. If the miss is determined to be a complete miss (S530=Yes) the stored prefetch data (DATA_S) is marked as trash data (S540), as described above. Otherwise, if the miss is determined to be a partial miss (S530=No) as described above, associated partial miss data (DATA_PM) will be detected (S550) as described above. Then, the prefetch unit 223 may be used to register the partial miss data as the trash data. That is, the prefetch unit 223 may be used to register data being updated by a write command among the prefetched data stored in the prefetch area 222 as trash data.

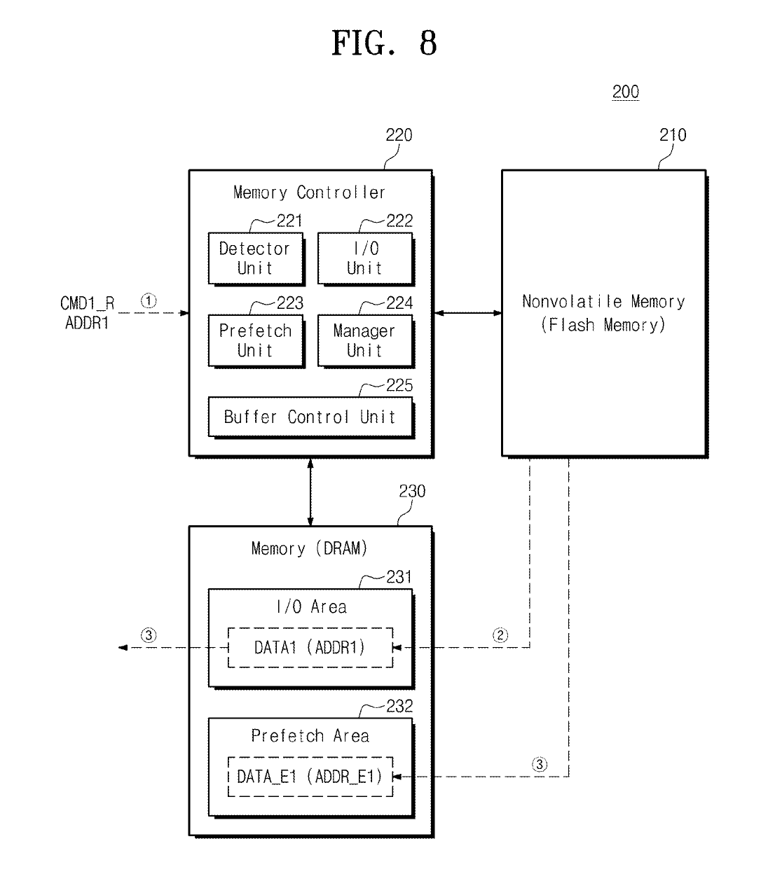

FIGS. 8, 9, 10, 11 and 12 (hereafter collectively, “FIGS. 8 through 12”) are respective block diagrams variously illustrating operation of the storage device 200 of FIG. 2 according to embodiments of the inventive concept. Referring to FIGS. 8 through 12, the memory controller 220 receives a first read command CMD1_R and a first read address ADDR1 from the host 100 \textcircled{1}. It is assumed that memory controller 220 receives the first read command CMD1_R and the first read address ADDR1 in a state wherein no data has been prefetched. For example, the first read command CMD1_R may be assumed to be a first command received by the memory controller 220 after power-on of the constituent computing system of FIG. 1.

Since no data has been prefetched, the I/O unit 222 requests that the manager unit 224 first read data DATA1 from the nonvolatile memory 210 in response to the first read command CMD1_R and on the basis of the first read address ADDR1, and the manager unit 224 reads the first read data DATA1 from the nonvolatile memory 210. The first read data DATA1 is then stored in the I/O area 231 of the memory 230 through the memory control unit 225 \textcircled{2}. This operation generally corresponds to step S330 described in relation to FIG. 5.

The first read data DATA1 stored in the I/O area 231 can then be output to the host 100 \textcircled{3}. This operation corresponds to step S335 in the method of FIG. 5.

On the basis of the first address ADDR1, the prefetch unit 223 may be used to anticipate a first prefetch address1 (ADDR_E1) as described above. On the basis of the first prefetch address, the prefetch unit 223 requests that the manager unit 224 read the first prefetched data (DATA_E1) from the nonvolatile memory 210, and the first prefetched data is stored in the prefetch area 232 of the memory 230 using the memory control unit 225 \textcircled{3}. This operation corresponds to steps S480 and S490 of the method of FIG. 6.

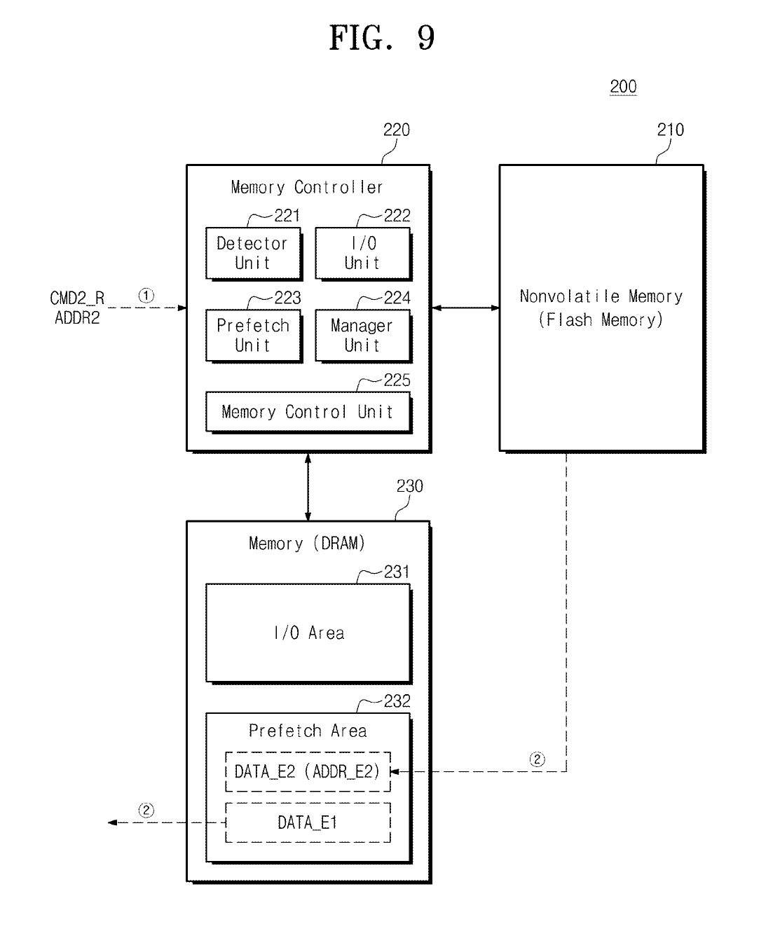

Referring now to FIGS. 1 and 9, it is further assumed that the memory controller 220 receives a second read command CMD2_R and a second read address ADDR2 from the host 100 \textcircled{1}. It is assumed that the second read address completely corresponds with the first prefetch address. That is, it is assumed that a hit conditions exits. Thus, in response to the second read command CMD2_R, the I/O unit 222 will output the first prefetch data (DATA_E1) stored in the prefetch area 232 to the host 100 \textcircled{2}. This operation corresponds to step S320 of the method of FIG. 5.

Also, on the basis of the second read address ADDR2, the prefetch unit 223 may be used to anticipate a second prefetch address, and on the basis of the second expected (ADDR_E2), the prefetch unit 223 may request that the manager unit 224 read second prefetch data (DATA_E2) from the nonvolatile memory 210. The combination of the manager unit 224 and memory control unit 230 reads the second prefetch data from the nonvolatile memory 210, and stores it in the prefetch area 232 of the memory 230 \textcircled{2}. For example, the second prefetch data (DATA_E2) may be loaded to the prefetch area 232 of the memory 230 while the I/O unit 222 is outputting the first prefetch data (DATA_E1) to the host 100.

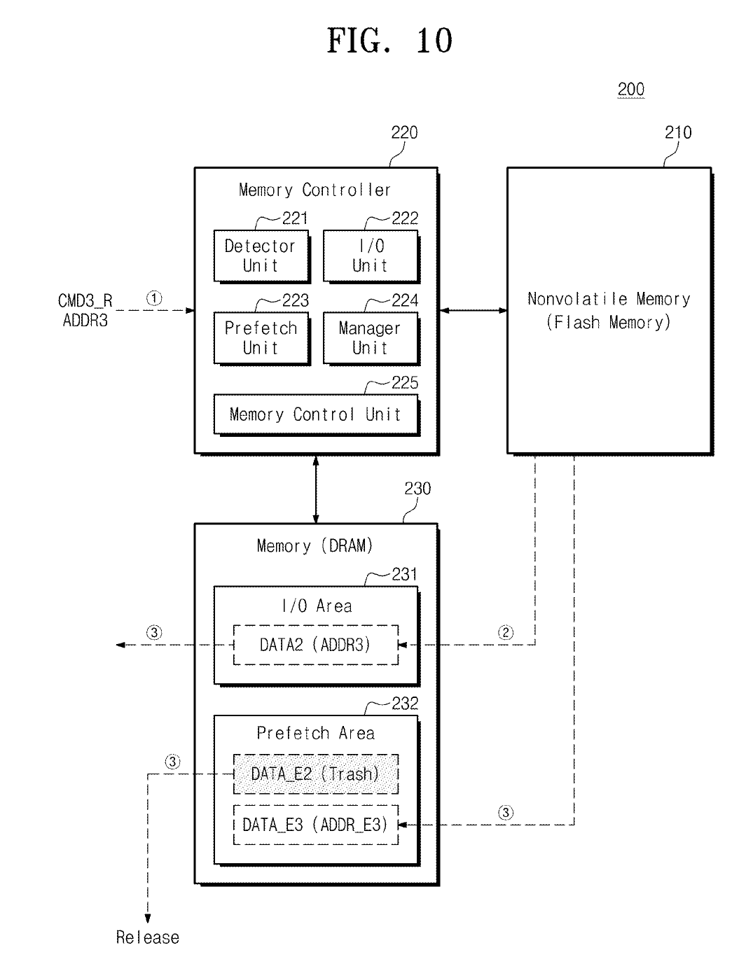

Referring now to FIGS. 1 and 10, it is further assumed that the memory controller 220 receives a third read command CMD3_R and a corresponding third read address ADDR3 from the host 100 \textcircled{1}.

It is also assumed that the third read address ADDR3 does not in any part correspond with the second prefetch address2 (i.e., a complete miss condition). In response to the third read command CMD3_R and on the basis of the third read address ADDR3, the I/O unit 222 requests that the manager unit 224 read the third data DATA3 from the nonvolatile memory 210. The manager unit 224 reads the third data DATA3 from the nonvolatile memory 210, and the third data DATA3 is then stored in the I/O area 231 of the memory 230 using the memory control unit 225 \textcircled{2}. This operation correspond to step 330 of the method of FIG. 5. Thereafter, the third data DATA3 stored in the I/O area 231 may be output to the host 100 \textcircled{3}, as in step S335 of the method of FIG. 5.

Also, since a complete miss condition is indicated, the prefetch unit 223 will mark the second prefetch data (DATA_E2) as a trash data \textcircled{3}, as in step S440 of the method of FIG. 6.

Now, on the basis of the third address ADDR3, the prefetch unit 223 may be used to anticipate a third prefetch address3. On the basis of the third prefetch (ADDR_E3), the prefetch unit 223 requests that the manager unit 224 read a third prefetch data (DATA_E3) from the nonvolatile memory 210. The manager unit 224 then reads the third prefetch data from the nonvolatile memory 210, and the third prefetch data is stored in the prefetch area 232 of the memory 230 using the memory control unit 225 \textcircled{3}.

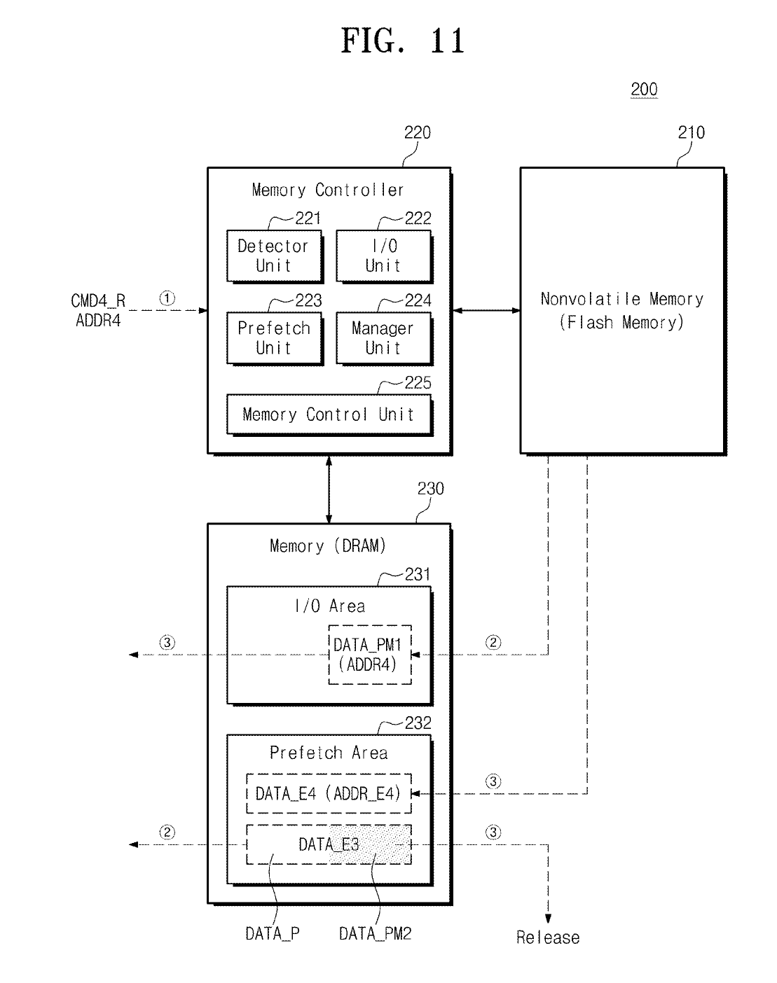

Referring now to FIGS. 1 and 11, it is further assumed that the memory controller 220 receives a fourth read command CMD4_R and a corresponding fourth read address ADDR4 from the host 100 \textcircled{1}.

It is also assumed that the fourth address ADDR4 partially corresponds with the third prefetch address3 (i.e., a partial hit/partial miss condition). Thus, in response to the fourth command CMD4_R, the I/O unit 222 will output partial hit data (DATA_P) from among the third prefetch data (DATA_E3) stored in the prefetch area 232 to the host 100 \textcircled{2} as in step S345 of the method of FIG. 5.

And in response to the fourth command CMD4_R and on the basis of the fourth address ADDR4, the I/O unit 222 requests that the manager unit 224 read first partial miss data (DATA_PM1) from the nonvolatile memory 210. The manager unit 224 will then read the first partial miss data from the nonvolatile memory 210, and the first partial miss will be stored in the I/O area 231 of the memory 230 using the memory control unit 225 \textcircled{2} as in step 350 of the method of FIG. 5.

The first partial miss data (DATA_PM1) stored in the I/O area 231 can then be output to the host 100 \textcircled{3} as in step S355 of the method of FIG. 5.

Because of the indicated partial miss/partial hit condition, the prefetch unit 223 will register second partial miss data (DATA_PM2) as trash data \textcircled{3} as in step S460 of the method of FIG. 6.

Also, on the basis of the fourth address ADDR4, the prefetch unit 223 may be used to anticipate a fourth prefetch address4. On the basis of the fourth prefetch address (ADDR_E4), the prefetch unit 223 requests that the manager unit 224 read fourth prefetch data (DATA_E4) from the nonvolatile memory 210. The manager unit 224 then reads the fourth prefetch data from the nonvolatile memory 210 and the fourth prefetch data is stored in the prefetch area 232 of the memory 230 using the memory control unit 225 \textcircled{3}, as in steps S480 and S490 of the method of FIG. 6.

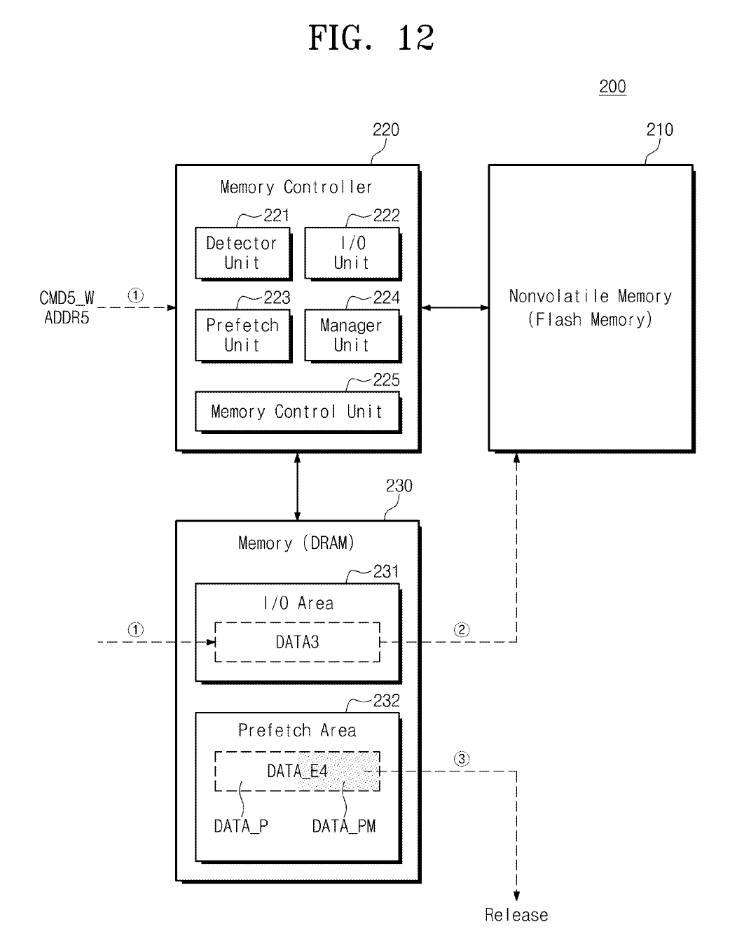

Referring now to FIGS. 1 and 12, it is further assumed that the memory controller 220 receives a write command (being fifth in the sequence of assumed commands) CMD5_W, a corresponding write address ADDR5, as well as write data DATA3 from the host 100 \textcircled{1}. The write data is stored in the I/O area 231 of the memory 230 using the memory control unit 225, and the I/O unit 222 may be used to write the write data in the nonvolatile memory 210 \textcircled{2}.

It is further assumed that write address ADDR5 corresponds in part to the fourth prefetch address4. That is, part data of the fourth prefetch data (DATA_E4) must be updated using at least part of the write data (DATA3). Thus, if the write data were used to only re-write data stored in the nonvolatile memory 210, at least a part of the fourth prefetch data stored in the prefetch area 232 of the memory 230 would not be valid. Thus, the prefetch unit 223 may be used to mark at least the partial miss data (DATA_PM) as a trash data as in the step S560 of the method of FIG. 7.

Once the partial miss data (DATA_PM) is marked as the trash data, even assuming a read command (e.g., a sixth command in the assumed sequence of command, CMD6_R) following the write command CMD5_W is directed to the fourth prefetch data (DATA_E4), embodiments of the inventive concept will not output invalid data currently stored in the prefetch area 232 to the host 100.

As described above, according to the illustrated embodiments of the inventive concept, the memory controller 220 may be used to fully or partially mark prefetch data as trash data, such as when all or part of stored prefetched data is updated during a write operation intervening read operations. This feature compares quite favorably with conventional approaches wherein, assuming a partial miss condition due to an intervening write operation updating current prefetch data, a subsequent read operation may be performed only after all of the prefetch data has been released, thereby destroying any benefits afforded by the already completed prefetch operation. In contrast, according to the illustrated embodiments of the inventive concept, regardless of whether a prefetch operation is completed, and regardless of whether prefetch data has been released, the memory controller 220 may execute a next operation immediately after the prefetch data is marked as trash data. Thus, computing systems and storage devices configured and operated in accordance with an embodiment of the inventive concept exhibit improved operating speed over conventional systems.

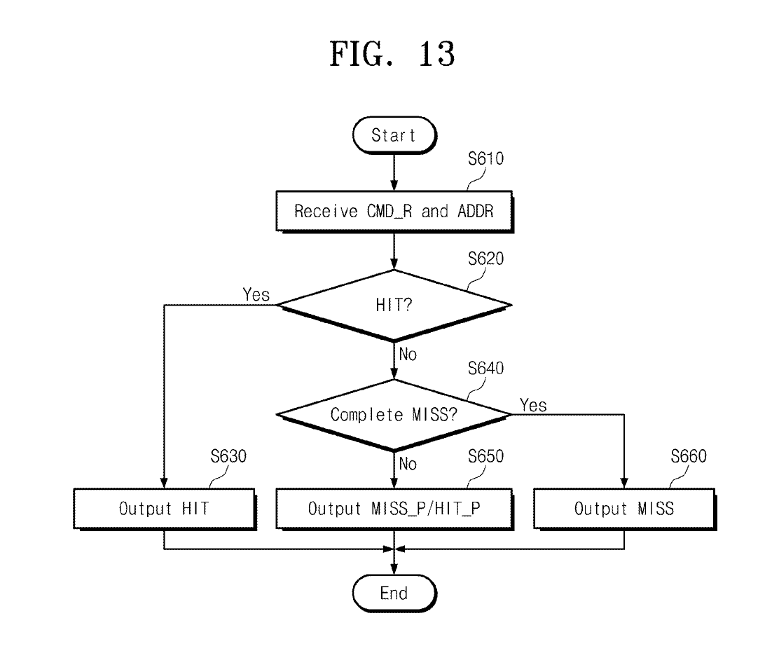

FIG. 13 is a flow chart illustrating in another example the operation of the detector unit 221 of FIG. 2 according to embodiments of the inventive concept. Referring to FIGS. 1, 2 and 13, the detector unit 221 may be sued to detect receipt of a read command (CMD_R) and a corresponding read address (ADDR) (S610).

The detector unit 221 then determines whether or not a hit condition exists (S620). For example, the detector unit 221 may receive an anticipated prefetch address from the prefetch unit 223, and compare the prefetch address with the received address. If the prefetch address fully corresponds with the received address, the detector unit 221 determines that a hit condition exists (S620=Yes) and output a HIT/MISS signal indicating a “HIT” (S630).

However, if a hit condition is not detected by the detector unit 221 (S620=No) and a miss condition is therefore indicated, a following determination is made as to whether or not the miss is a complete miss (S640). Upon determining a partially miss/partially hit condition (S640=No), the detector unit 221 may be used to output a partial miss/partial hit signal (MISS_P/HIT_P) (S650). Otherwise, if a complete miss condition is indicated (S620=No and S640=Yes), the detector unit 221 will output a HIT/MISS signal indicated a “MISS” (S660).

Thus, the function of determining whether a miss is a partially miss or a complete miss may be provided to the detector unit 221. Hence, the I/O unit 222 and prefetch unit 223 may be configured according to the illustrated embodiment of FIG. 13 to receive either a hit signal (HIT), a partial hit/partial miss signal (HIT_P/HIT_P), or a miss signal (MISS) from the detector unit 221.

That is, consistent with the foregoing embodiments, the I/O unit 222 may be configured to perform step S320 in response to the hit signal (HIT), perform step S340 in response to the partial hit/partial miss signal (MISS_P/HIT_P), or perform step S330 in response to the miss signal (MISS).

In a case where a partial miss/hit occurs, a range of prefetch data (DATA_E) may be considered in relation to the partially miss/hit by use of the detector unit 221. For example, partial hit data (DATA_P), first partial miss data (DATA_PM1) or second partial miss data (DATA_PM2) from the foregoing illustrated example may be determined using the detector unit 221. In such cases, the I/O circuit 222 may be used to perform step S345 in response to the partial hit/partial miss signal (MISS_P/HIT_P).

The prefetch unit 223 may be used to perform step S470 in response to the hit signal (HIT), perform step S450 in response to the partial hit/partial miss signal (MISS_P/HIT_P), or perform step S440 in response to the miss signal (MISS).

In a case where a partially hit/miss condition is detected, a range of prefetch data (DATA_E) may be considered by the detector unit 221. For example, the partial hit data (DATA_P), first partial miss data (DATA_PM1) or second partial miss data (DATA_PM2) from the foregoing illustrated examples may be determined by the detector unit 221. In such cases, the prefetch unit 223 may be used to perform step S460 in response to the partial hit signal HIT_P or the partial miss signal MISS_P.

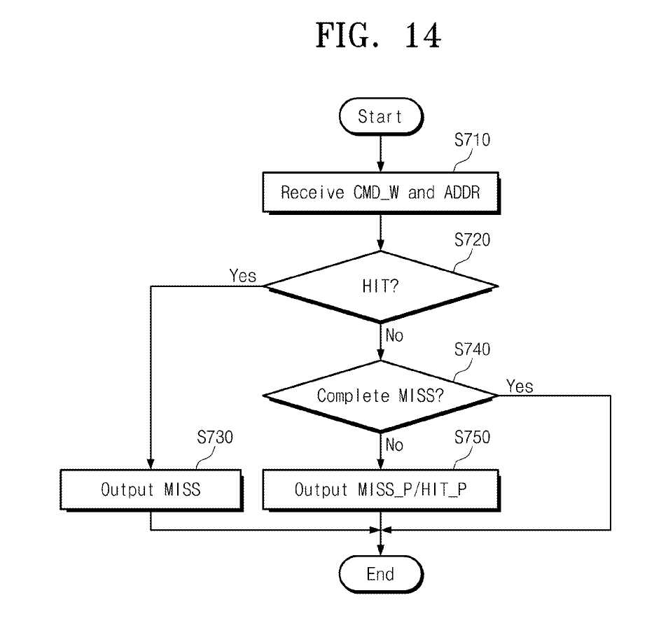

FIG. 14 is a flow chart illustrating in yet another example the operation of the detector unit 221 of FIG. 2 according to still other embodiments of the inventive concept. Referring to FIGS. 1, 2 and 14, the detector unit 221 is assumed to receive a write command CMD_W and a corresponding write address ADDR (S710).

The detector unit 221 may then be used as previously described to determine whether or not a hit condition exits (S720), and if a hot condition exists (S720=Yes), the detector unit 221 outputs a miss signal (MISS). Otherwise, the detector unit 221 determines whether the miss is a complete miss (S740).

If the miss is a partial miss (S740=No), the detector unit 221 outputs a partial miss signal/partial hit (MISS_P/ HIT_P) (S750), where a complete miss generate no separate control signal indication.

In this manner, the function of determining whether a miss is a complete or partial miss may be provided by the detector unit 221. The prefetch unit 223 may be configured to receive the hit signal (HIT), the partial hit signal (HIT_P) or the partial miss signal (MISS_P), or a miss signal (MISS) and operate according to the received signals.

Thus, the prefetch unit 223 may perform step S550 in response to the partial hit signal (HIT_P) or the partial miss signal (MISS_P), and perform step S540 in response to the miss signal (MISS). In a case where a partial hit/miss occurs, a range of prefetched data (DATA_E) may be considered by the detector unit 221.

Thus, in certain embodiments of the inventive concept, the detector unit 221 may be configured output similar hit/miss and/or partial hit/miss control signals regardless of the type of command received (i.e., a read command or a write command). However, in other embodiments of the inventive concept, the detector unit 221 may be configured to output separate (or different) control signals depending on whether a read command or a write command is received.

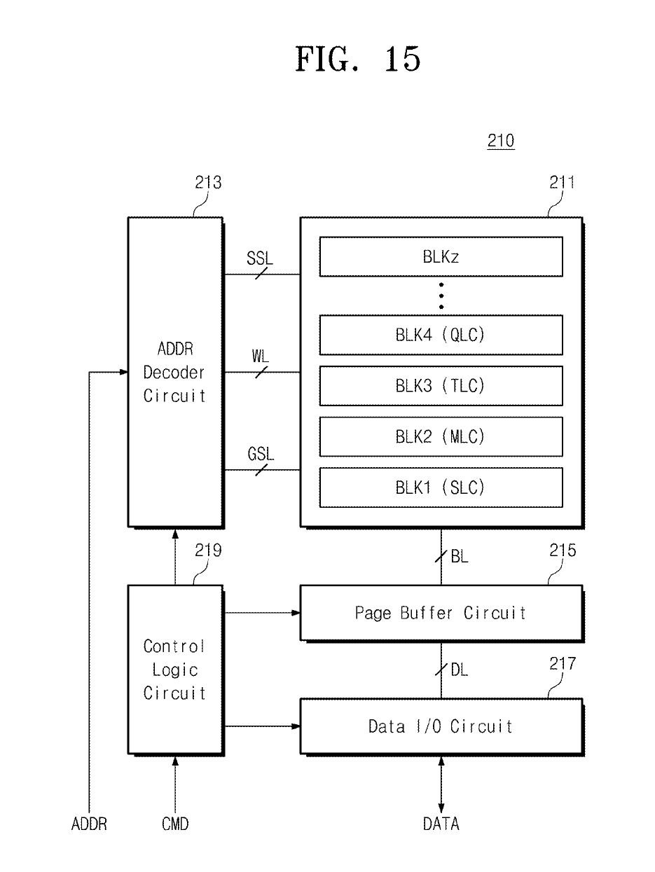

FIG. 15 is a block diagram further illustrating in one example the nonvolatile memory 210 of FIG. 2. Referring to FIG. 15, the nonvolatile memory 210 comprise a memory cell array 211, an address decoder circuit 213, a page buffer circuit 215, a data I/O circuit 217 and control logic circuit 219.

The memory cell array 211 includes a plurality of memory blocks BLK1˜BLKz. Each memory block includes a plurality of memory cells. Each memory block can be connected to the address decoder 213 through at least one ground select line GSL, a plurality of word lines WL and at least one string select line SSL. Each memory block can be connected to the page buffer circuit 215 through a plurality of bit lines BL. The memory blocks BLK1˜BLKz can be connected to a plurality of bit lines BL in common. Memory cells of the memory blocks BLK1˜BLKz can have the same structure.

The address decoder circuit 213 is connected to the memory cell array 211 through a plurality of ground select lines GSL, a plurality of word lines WL and a plurality of string select lines SSL. The address decoder circuit 213 operates under the control of the control logic circuit 219. The address decoder circuit 213 can receive an address from the memory controller 220 (refer to FIG. 3). The address decoder circuit 213 decodes the received address ADDR and can control voltages being applied to the word lines WL according to the decoded address. For example, in a program operation, the address decoder circuit 213 can apply a pass voltage to the word lines WL under the control of the control logic circuit 219. In a program operation, the address decoder circuit 213 can further apply a program voltage to a word line indicated by the address ADDR among the word lines WL under the control of the control logic circuit 219.

The page buffer circuit 215 is connected to the memory cell array 211 through a plurality of bit lines BL. The page buffer circuit 215 is connected to the data I/O circuit 217 through a plurality of data lines DL. The page buffer circuit 215 operates according to a control of the control logic circuit 219.

The page buffer circuit 215 can store data to be programmed or data being read from memory cells in memory cells of the memory cell array 211. In a program operation, the page buffer circuit 215 can store data to be programmed in the memory cells. On the basis of the stored data, the page buffer circuit 215 can bias a plurality of bit lines BL. In a program operation, the page buffer circuit 215 can function as a write driver. In a read operation, the page buffer circuit 215 can sense voltages of the bit lines BL and can store the sensed result. In a read operation, the page buffer circuit 215 can function as a sensing amplifier.

The data I/O circuit 217 is connected to the page buffer circuit 215 through a plurality of data lines DL. The data I/O circuit 217 can exchange data with the memory controller 220 (refer to FIG. 3).

The data I/O circuit 217 can temporarily store data DATA being received from the memory controller 220. The data I/O circuit 217 can transmit the stored data to the page buffer circuit 215. The data I/O circuit 217 can temporarily store data DATA being transmitted from the page buffer circuit 215. The data I/O circuit 217 can transmit the stored data DATA to the memory controller 220. The data I/O circuit 217 can function as a buffer memory.

The control logic circuit 219 receives a command CMD from the memory controller 220. The control logic circuit 219 decodes the received command CMD and can control the overall operation of the nonvolatile memory 210 according to the decoded command CMD. The control logic circuit 219 may further receive various control signals and voltages from the memory controller 220.

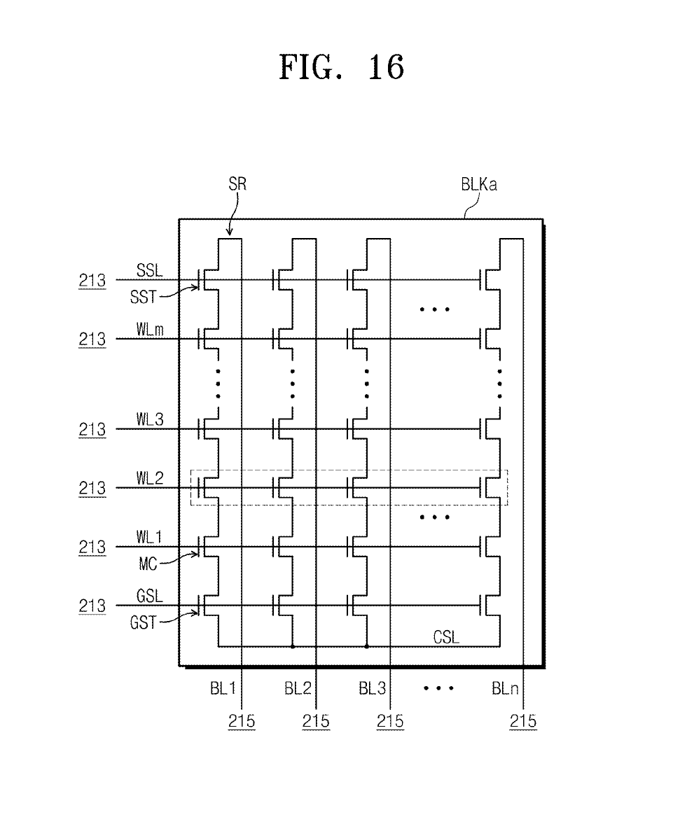

FIG. 16 is a circuit diagram illustrating a memory block in accordance with embodiments of the inventive concept. one memory block BLKa among the memory blocks BLK1˜BLKz of the memory cell array 211 of FIG. 15 is illustrated in FIG. 16.

Referring to FIGS. 15 and 16, the memory block BLKa includes a plurality of strings SR. The strings SR can be connected to a plurality of bit lines BL respectively. Each string SR includes a ground select transistor GST, memory cells MC and a string select transistor SST.

A ground select transistor GST of each string SR is connected between the memory cells MC and a common source line CLS. Ground select transistors GST of a plurality of strings SR are connected to the common source line CSL in common.

A string select transistor SST of each string SR is connected between the memory cells MC and a bit line BL. String select transistors SST of a plurality of strings SR are connected to a plurality of bit lines BL1˜BLn respectively. The bit lines BL1˜BLn can be connected to the page buffer circuit 215.

In each string SR, a plurality of memory cells MC is provided between the ground select transistor GST and the string select transistor SST. In each string SR, the memory cells MC can be serially connected.

In the strings SR, memory cells MC located at the same order from the common source line CSL can be connected to one word line in common. Memory cells MC of the strings SR may be connected to a plurality of word lines WL1˜WLm. The word lines WL1˜WLm can be connected to the address decoder circuit 213.

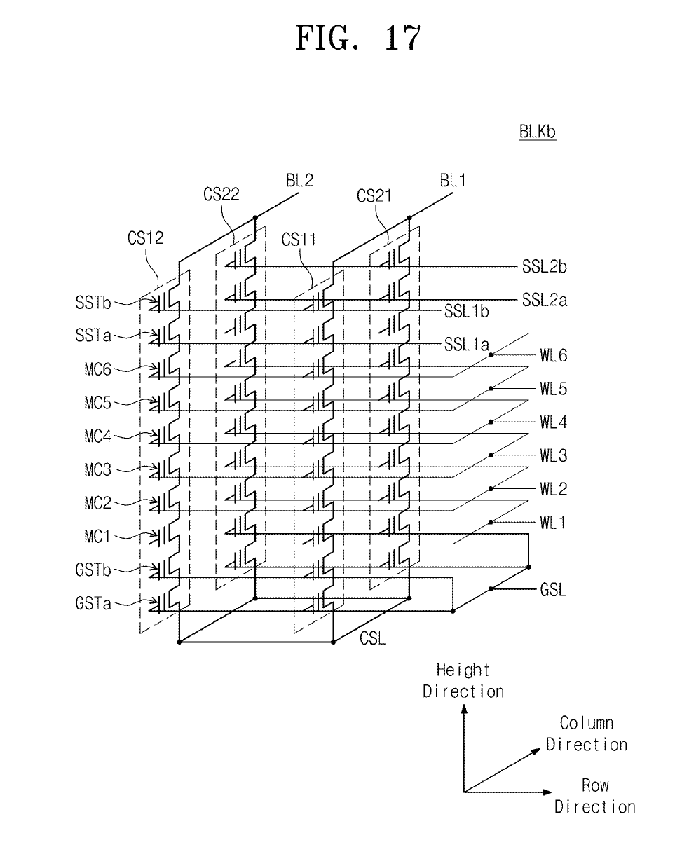

FIG. 17 is a circuit diagram illustrating a memory block BLKb in accordance with certain embodiments of the inventive concept. Referring to FIG. 17, the memory blocks BLKb includes a plurality of cell strings CS11˜CS21 and CS12˜CS22. The cell strings CS11˜CS21 and CS12˜CS22 are arranged along a row direction and a column direction to form rows and columns

Cell strings CS11 and CS12 arranged along a row direction can form a first row and cell strings CS21 and CS22 arranged along a row direction can form a second row. Cell strings CS11 and CS21 arranged along a column direction can form a first column and cell strings CS12 and CS22 arranged along a row direction can form a second column.

Each cell string may include a plurality of cell transistors. The cell transistors include ground select transistors GSTa and GSTb, memory cells MC1˜MC6 and string select transistors SSTa and SSTb. The ground select transistors GSTa and GSTb, the memory cells MC1˜MC6 and the string select transistors SSTa and SSTb of each string can be stacked in a direction perpendicular to a plane (e.g., a substrate of the memory block BLKb) on which the cell strings CS11˜CS21 and CS12˜CS22 are arranged along a row direction and a column direction.

The lowermost ground select transistors GSTa can be connected to the common source line CSL in common. The ground select transistors GSTa and GSTb of the cell strings CS11˜CS21 and CS12˜CS22 can be connected to a ground select line GSL in common.

Ground select transistors having the same height (or order) are connected to the same ground select line and ground select transistors having different heights (or orders) are connected to different ground select lines. For example, ground select transistors GSTa having a first height may be connected to a first ground select line and ground select transistors GSTa having a second height may be connected to a second ground select line.

Ground select transistors of the same row are connected to the same ground select line and ground select transistors of different rows are connected to different ground select lines. For example, ground select transistors GSTa of the cell strings CS11 and CS12 of a first row may be connected to a first ground select line and ground select transistors GSTa of the cell strings CS21 and CS22 of a second row may be connected to a second ground select line.

Memory cells located at the same height (or order) from the substrate (or the ground select transistors GST) are connected to one word line and memory cells located at different heights (or orders) from the substrate (or the ground select transistors GST) are connected to different word lines WL1˜WL6 respectively. For example, the memory cells MC1 are connected to the word line WL1 in common. The memory cells MC2 are connected to the word line WL2 in common. The memory cells MC3 are connected to the word line WL3 in common. The memory cells MC4 are connected to the word line WL4 in common. The memory cells MC5 are connected to the word line WL5 in common. The memory cells MC6 are connected to the word line WL6 in common.

In the first string select transistors SSTa of the same height of the cell strings CS11˜CS21 and CS12˜CS22, the first string select transistors of different rows are connected to different string select lines SSL1a and SSL2a. For example, the first string select transistors SSTa of the cell strings CS11 and CS12 are connected to the string select line SSL1a in common. The first string select transistors SSTa of the cell strings CS21 and CS22 are connected to the string select line SSL2a in common.

In the second string select transistors SSTb of the same height of the cell strings CS11˜CS21 and CS12˜CS22, the second string select transistors of different rows are connected to different string select lines SSL1b and SSL2b. For example, the second string select transistors SSTb of the cell strings CS11 and CS12 are connected to the string select line SSL1b in common. The second string select transistors SSTb of the cell strings CS21 and CS22 are connected to the string select line SSL2b in common.

That is, cell strings of different rows are connected to different string select lines. String select transistors of the same height (or order) of cell strings of the same row are connected to the same string select line. String select transistors of different heights (or orders) of cell strings of the same row are connected to different string select lines.

String select transistors of cell strings of the same row may be connected to one string select line in common. For example, the string select transistors SSTa and SSTb of the cell strings CS11 and CS12 of the first row can be connected to one string select line in common. The string select transistors SSTa and SSTb of the cell strings CS21 and CS22 of the second row can be connected to one string select line in common.

Columns of the cell strings CS11˜CS21 and CS12˜CS22 are connected to different bit lines BL1 and BL2 respectively. For example, the cell select transistors SSTb of the cell strings CS11 and CS21 of a first column are connected to the bit line BL1 in common. The cell select transistors SSTb of the cell strings CS12 and CS22 of a second column are connected to the bit line BL2 in common.

The memory block BLKb illustrated in FIG. 17 is an illustration. A technical spirit of the inventive concept is not limited to the memory block BLKb illustrated in FIG. 17. For example, the number of rows of cell strings may increase or decrease. As the number of rows of cell strings is changed, the number of string select lines or ground select lines connected to rows of the cell strings and the number of cell strings connected to one bit line may be changed.

The number of columns of cell strings may increase or decrease. As the number of columns of cell strings is changed, the number of bit lines connected to columns of the cell strings and the number of cell strings connected to one string select line may be changed.

A height of the cell strings may increase or decrease. For example, the number of ground select transistors, memory cells or string select transistors that are stacked in each string may increase or decrease.

Write and read operations can be performed by a row unit of the cell strings CS11˜CS21 and CS12˜CS22. The cell strings CS11˜CS21 and CS12˜CS22 can be selected by a row unit by the string select lines SSL1a, SSL1b, SSL2a and SSL2b.

In a selected row of the cell strings CS11˜CS21 and CS12˜CS22, write and read operations can be performed by a word line unit. In a selected row of the cell strings CS11˜CS21 and CS12˜CS22, memory cells connected to the selected word line may be programmed.

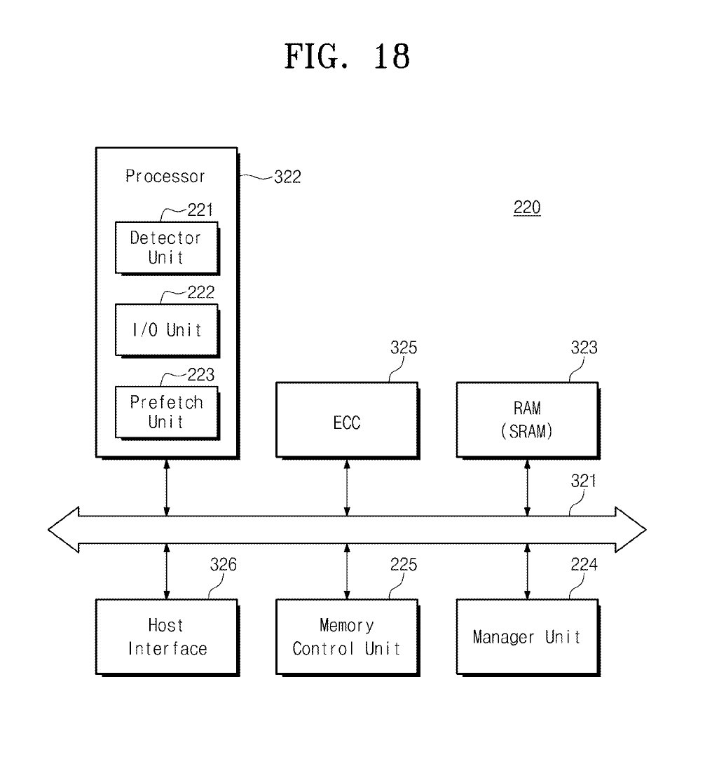

FIG. 18 is a block diagram illustrating in one example the memory controller 220 of FIG. 2. Referring to FIG. 18, the memory controller 220 comprises a bus 321, a processor 322, a memory 323, a manager unit 224, a memory control unit 225, an error correction block 325 and a host interface 326.

The bus 321 is configured to provide a channel between constituent elements of the memory controller 220.

The processor 322 can control the overall operation of the memory controller 220 and perform a logical operation. The processor 322 can communicate with the external host 100 (refer to FIG. 1) through the host interface 326. The processor 322. The processor 322 can communicate with the external nonvolatile memory 210 (refer to FIG. 2) through the manager unit 224. The processor 322 may include a microcontroller.

The memory 323 can be used as an operation, cache or buffer memory of the processor 322. The memory 323 can store codes and commands which the processor 322 executes. The memory 323 can store data being processed by the processor 322. The memory 323 may include a SRAM.

The manager unit 224 can communicate the nonvolatile memory 210 under the control of the processor 322.

The memory control unit 225 can control the memory 230 (refer to FIG. 2).

The error correction block 325 can perform an error. The error correction block 325 can generate parity for performing an error correction on the basis of data to be written in the nonvolatile memory 210. The data and the parity may be transmitted to the nonvolatile memory 210 through the manager unit 224 and may be written in the nonvolatile memory 210. The error correction block 325 can perform an error correction using data and parity being read from the nonvolatile memory 210 through a memory interface.

The host interface 326 can communicate with the external host 100 under the control of the processor 322. The host interface 326 can communicate with the external host 100 on the basis of at least one of various protocols such as a USB (universal serial bus) protocol, a serial-ATA (SATA) protocol, a SCSI (small computer small interface) protocol, a Firewire protocol, a PCI (peripheral component interconnection) protocol, a NVMe protocol.

The detector unit 221, the I/O unit 222 and the prefetch unit 223 can be embodied by software being driven in the processor 322. However, a technical spirit of the inventive concept is not limited thereto. At least one of the detector unit 221, the I/O unit 222 and the prefetch unit 223 can be embodied by combinations of hardware and software.

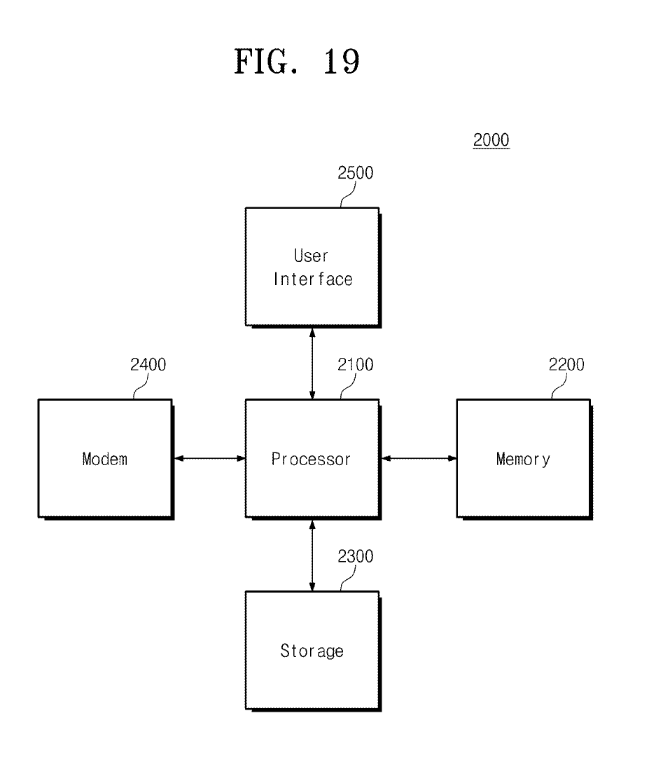

FIG. 19 is a block diagram illustrating a computing device 2000 in accordance with certain other embodiments of the inventive concept. Referring to FIG. 19, the computing device 2000 generally comprises a processor 2100, a memory 2200, storage 2300, a modem 2400, and a user interface 2500.

The processor 2100 controls the overall operation of the computing device 2000 and performs a logical operation. For example, the processor 2100 can be constituted by a system on chip (SoC). The processor 2100 may be a general-purpose processor being used in a general-purpose computer, a special-purpose processor being used in a special-purpose computer, or an application processor being used in a mobile computing device.

The memory 2200 can communicate with the processor 2100. The memory 2200 may be a main memory of the processor 2100 or the computing device 2000. The processor 2100 can temporarily store code or data in the memory 2200. The processor 2100 can execute code and process data using the memory 2200. The processor 2100 can execute various kinds of software such as an operating system, an application, etc. using the memory 2200. The processor 2100 can control the overall operation of the computing device 2000 using the memory 2200. The memory 2200 may include a volatile memory such as a SRAM, a DRAM, a SDRAM, etc. and a nonvolatile memory such as a flash memory, a PRAM, a MRAM, a RRAM, a FRAM, etc. The memory 2200 can be constituted by a random access memory.

The storage 2300 may be a storage medium that stores data being used in the computing device 2000 for a long time. The storage 2300 may include a storage device 200 in accordance with embodiments of the inventive concept.

The modem 2400 can communicate with an external device under the control of the processor 2100. For example, the modem 2400 can perform a wired or wireless communication with an external device. The modem 2400 can perform a communication on the basis of at least one of various wireless communication methods such as a long term evolution (LTE), a WiMax, a global system for mobile communication (GSM), a code division multiple access (CDMA), a Bluetooth, a near field communication (NFC), a WiFi, a radio frequency Identification (RFID), or at least one of various wired communication methods such as a universal serial bus (USB), a serial at attachment (SATA), a small computer small interface (SCSI), a Firewire, a peripheral component interconnection (PCI), etc.

The user interface 2500 can communicate with a user under the control of the processor 2100. For example, the user interface 2500 may include user input interfaces such as a keyboard, a keypad, a button, a touch panel, a touch screen, a touch pad, a touch ball, a camera, a mike, a gyroscope sensor, a vibration sensor, etc. The user interface 2500 may include user output interfaces such as a liquid crystal display (LCD), an organic light emitting diode (OLED) display, an active matrix OLED (AMOLED) display, a LED, a speaker, a motor, etc.

According to exemplary embodiments of the inventive concept, a memory controller expects data to be requested by a host in advance and reads the expected data from a nonvolatile memory in advance to store it. In the case that expectation is succeeded, since data stored in advance is output, an operation speed of a storage device is improved. In the case that expectation is failed, the memory controller registers the stored data in advance as trash data and then performs a next operation. The trash data is periodically checked and released. Even if expectation is failed, since the memory controller performs a next operation, an operation speed of the storage device is improved.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An operating method for a storage device including a nonvolatile memory, a memory and a memory controller that controls the nonvolatile memory and memory, the method comprising:
receiving in the memory controller a first read command and a corresponding first address from a host;
in response to the first read command and by operation of the memory controller,
reading first data from the nonvolatile memory in response to the first address, providing the first data to the host, anticipating a first prefetch address in response to the first address, reading first prefetch data from the nonvolatile memory in response to the first prefetch address, and storing the first prefetch data in the memory;
receiving in the memory controller a second read command and a corresponding second address from the host following receipt of the first read command and the first address;
determining on the basis of the first prefetch address and the second address whether the first prefetch data corresponds with second data stored in the nonvolatile memory as identified by the second address; and
upon determining that the first prefetch data completely corresponds with the second data, providing the first prefetched data from the memory to the host,
upon determining that the first prefetch data does not correspond with the second data, reading the second data from the nonvolatile memory, temporarily storing the second data in the memory and then providing the second data to the host, and marking the first prefetch data stored in the memory as trash data.

2. The method of claim 1, wherein first data and the second data are stored in the nonvolatile memory according to consecutive addresses.

3. The method of claim 1, wherein first data and the second data are stored in the nonvolatile memory according to a predetermined pattern.

4. The method of claim 1, further comprising:
upon determining that the first prefetch data partially correspond with the second data, providing corresponding portion of the first prefetch data to the host, and marking noncorresponding portion of the first prefetch data stored in the memory as the trash data.

5. The method of claim 1, wherein the first prefetch data is stored in a prefetch area of the memory and the second data is stored in an input/output area of the memory separate from the prefetch area.

6. The method of claim 1, further comprising:
in response to the second read command and by operation of the memory controller,
anticipating a second prefetch address in response to the second address, reading second prefetch data from the nonvolatile memory in response to the second prefetch address, and storing the second prefetch data in the memory.

7. The method of claim 1, wherein the determining on the basis of the first prefetch address and the second address of whether the first prefetch data corresponds with second data stored in the nonvolatile memory as identified by the second address comprises:
comparing a range of address values in the first prefetch address with a range of address values in the second address.

8. The method of claim 1, further comprising:
releasing the first prefetch data marked in the memory as trash data in response to a command issued from the memory controller, or according to a periodic schedule.

9. An operating method for storage device including a nonvolatile memory, a memory and a memory controller that controls the nonvolatile memory and memory, the method comprising:
receiving in the memory controller a first read command and a corresponding first address from a host;
in response to the first read command and by operation of the memory controller, reading first data from the nonvolatile memory in response to the first address, providing the first data to the host, anticipating a first prefetch address in response to the first address, reading first prefetch data from the nonvolatile memory in response to the first prefetch address, and storing the first prefetch data in the memory;
receiving in the memory controller a second read command and a corresponding second address from the host following receipt of the first read command and the first address;
determining on the basis of the first prefetch address and the second address whether a hit condition or a miss condition exists with respect to the first prefetch data and second data stored in the nonvolatile memory as identified by the second address; and
upon determining that the hit condition exists, providing the first prefetched data from the memory to the host,
upon determining that the miss condition exists, reading the second data from the nonvolatile memory in response to the second address, temporarily storing the second data in the memory and then providing the second data to the host, and marking the first prefetch data stored in the memory as trash data.

10. The method of claim 9, further comprising:
releasing the first prefetch data marked in the memory as the trash data in response to a command issued from the memory controller or according to a periodic schedule.

11. The method of claim 9, further comprising:
upon determining that the miss condition is a partial miss condition,
detecting partial hit data among the first prefetched data stored in the memory and outputting the partial hit data to the host; and
marking partial miss data among the first prefetch data stored in the memory as the trash data.

12. The method of claim 9, further comprising:
in response to the second read command and by operation of the memory controller, anticipating a second prefetch address in response to the second address, reading second prefetch data from the nonvolatile memory in response to the second prefetch address, and storing the second prefetch data in the memory.

13. The method of claim 12, further comprising:
receiving in the memory controller a write command, a corresponding write address, and write data from the host, wherein the write command is received after the receipt of the second read command;
upon determining that the second prefetch address completely corresponds to the write address, marking the second prefetch data stored in the memory as the trash data.

14. The method of claim 13, further comprising:
upon determining that the second prefetch address partially corresponds to the write address, marking a portion of the second prefetch data identified by a portion of the second prefetch address corresponding to the write address as the trash data.

15. The method of claim 13, further comprising:
upon determining that the second prefetch address does not corresponds to the write address, maintaining the second prefetch data in the memory.

16. A storage device comprising:
a nonvolatile memory;
a memory; and
a memory controller that receives a first read command and a corresponding first address from a host,
wherein in response to the first read command the memory controller is configured to read first data from the nonvolatile memory in response to the first address, provides the first data to the host, anticipates a first prefetch address in response to the first address, reads first prefetch data from the nonvolatile memory in response to the first prefetch address, and stores the first prefetch data in the memory,
the memory controller also receives after the first read command a second read command and a corresponding second address from the host,
wherein in response to the second read command the memory controller is configured to determine on the basis of the first prefetch address and the second address whether the first prefetch data corresponds with second data stored in the nonvolatile memory as identified by the second address, and upon determining that the first prefetch data completely corresponds with the second data, the memory controller provides the first prefetched data from the memory to the host, and upon determining that the first prefetch data does not corresponds with the second data, the memory controller marks the first prefetch data as trash data.

17. The storage device of claim 16, wherein the memory controller stores the first prefetch data in a prefetch area of the memory and stores the second data in an input/output area of the memory separate from the prefetch area.

18. The storage device of claim 16, wherein in response to the second read command the memory controller is configured to anticipate a second prefetch address in response to the second address, read second prefetch data from the nonvolatile memory in response to the second prefetch address, and store the second prefetch data in the memory.

19. The storage device of claim 16, wherein the nonvolatile memory is a flash memory having a plurality of cell strings arranged in rows and columns on a substrate, each cell string including at least one ground select transistor, a plurality of memory cells and at least one string select transistor sequentially stacked on the substrate along a direction perpendicular to the substrate.

20. The storage device of claim 16, wherein the nonvolatile memory, the memory and the memory controller form a solid state drive SSD.
